(19) United States
(12) Patent Application Publication
(10) Pub. No.: US 2021/0329098 A1
(43) Pub. Date: Oct. 21, 2021

(54) METHODS OF OPERATING SERVICE INSTANCE SETS AND/OR SET RESTORATION STORAGE RESOURCES AND RELATED NETWORK NODES

(71) Applicant: Telefonaktiebolaget LM Ericsson (publ), Stockholm (SE)

(72) Inventors: Maria Cruz BARTOLOMÉ RODRIGO, Madrid (ES); Attila MIHÁLY, Dunakeszi (HU)

(21) Appl. No.: 17/295,365

(22) PCT Filed: Nov. 19, 2019
(86) PCT No.: PCT/EP2019/081778

§ 371 Date: May 19, 2021

(30) Foreign Application Priority Data
Nov. 19, 2018 (EP) 18382828.4

(51) Int. Cl. H04L 29/08; H04L 29/06

(52) U.S. Cl. CPC H04L 67/327; H04L 67/42; H04L 67/142

(57) ABSTRACT

An operation request, including a context identifier, is received for an instance of a service in a service instance set. An update is transmitted for information relating to a context associated with the context identifier at a set restoration storage resource node using the instance of the service responsive to receiving the operation request. Responsive to determining that a context associated with the context identifier is unavailable from a storage resource associated with the service instance set, information relating to the context is accessed from a set restoration storage resource. The context is updated at the storage resource associated with the service instance set responsive to receiving the operation request and responsive to receiving the information relating to the context from the set restoration storage resource.

The present disclosure relates generally to communications, and more particularly to communication networks and related methods and network nodes/entities/functions/servers. 5G System Rel-15 has been released as documented in 3GPP TS 23.502 v15.3.0 “Procedures for 5G System; Stage 2” and 3GPP TS 23.501 v15.3.0 “System Architecture for 5G System; Stage 2”.

The 5GC Control Plane as being defined in ongoing Rel-15 includes a disruptive change: traditional (pre-5GC) peer-to-peer interfaces and protocols are now replaced by a so-called SBA (Service Based Architecture), where each logical Network Function (NF) exposes one or multiple well-defined services (as a producer) to whatever other NF acting as service consumer by means of versioned HTTP2/REST APIs known as Service Based Interfaces (SBI). That is, there will be a network domain (basically the core network, CN) in which the different functional components are defined as Services, which are self-contained functionalities that can be changed and modified in an isolated manner (without affecting the other services).

A new Network Function named NRF (Network Repository Function) has been defined to provide NF-service discovery capabilities in 5GC, allowing NF-service producers to register their exposed NF-services (invoking the “NFRegister” operation offered through the “Nnrf_NFManagement” service by a NRF instance) for later NF-service consumers to discover them (through NRF exposed “Nnrf_NFDiscovery” service). A NF instance acting as service provider provides/updates at NF service registration time its “NF profile”, including (among other information) all provided NF services and, for each of them, the related end-point addresses.

The services in 5GC will likely be built in a stateless way, i.e., the business logic and data context will be separated. This means that the services store their context externally in a proprietary DB. This will enable various cloud infrastructure features like auto-scaling or auto-healing.

In the context of the envisaged enhanced SBA (eSBA) as disclosed in 3GPP TR 23.742 v1.0.0 “Study on Enhancements to the Service-Based Architecture” (in the following denoted as “eSBA TR”) a concept of a set of instances is discussed, see therein Solution 11 in clause 6.11.

This solution proposes to define a Services Instance Set concept that can support high reliability and also has potential to improve other aspects of the 5GC architecture. A Service Instance Sets comprises a set of instances of the same service type, wherein all Service instances in a set can access the same data storage e.g. UDSF.

As shown in FIG. 9, which corresponds to figure 6.11.2-1 of eSBA TR, a Service Instance Set has a storage resource accessible by all service Instances in the Set. A Service Instance Set may expose individual service instances towards consumers or it can use a load balancer. If a load balancer is used the Service Instance Set may appear as one Service Instance towards consumers.

When a Service Instance Set exposes multiple service instances towards a consumer, the consumer is allowed to reselect a different Service Instance (within the same set) between transactions.

As shown in FIG. 10, which corresponds to figure 6.11.2-2 of eSBA TR, a Service Instance Set may span multiple data centres.

As well, in the context of the eSBA TR, a requirement may be to achieve an independent management per each service, but sometimes this may not be possible as long as some defined services (in Rel-15) have some common data, that is accessed internally by implementation dependent interfaces. One possible solution for that problem is to do not consider those services as independent from a management perspective, but consider a group, referred to as a “deployment unit”. This deployment unit may include two or more instances of different service types that are deployed together and are single vendor. Since the Service instances within the deployment unit may share some data, it may be difficult to accommodate access to a same Storage Resource for different operations relating to a same context.

### SUMMARY

There is provided a method of operating a service instance set of a communication network. An operation request is received for an instance of a service in a service instance set. The operation request may include a context identifier. An update is transmitted for information relating to a context associated with the context identifier at a set restoration storage resource node using the instance of the service responsive to receiving the operation request.

There is also provided a further method of operating a service instance set for a service of a communication network. An operation request for the service is received from a consumer node, wherein the operation request includes a context identifier. Responsive to determining that a context associated with the context identifier is unavailable from a storage resource associated with the service instance set, information relating to the context is accessed from a set restoration storage resource. The context is updated at the storage resource associated with the service instance set responsive to receiving the operation request and responsive to receiving the information relating to the context from the set restoration storage resource.

There is further provided a method of operating a set restoration storage resource node of a communication network. An update for information relating to a context is received from a first service instance set, and a request for access to the information relating to the context is received from a second service instance set. The information relating to the context is transmitted to the second service instance set responsive to receiving the request.

There are further provided service instance sets, or service instance set nodes, and a set restoration storage resource node, adapted to perform the respective methods.

According to some embodiments, deployment of multiple service instance sets for a same service type by the same or different vendors may be supported.

### BRIEF DESCRIPTION OF THE DRAWINGS

The accompanying drawings, which are included to provide a further understanding of the disclosure and are incorporated in and constitute a part of this application, illustrate certain non-limiting embodiments. In the drawings:

FIG. 1 is a block diagram illustrating service A instances deployed in two sets (also referred to as groups);

FIG. 2 is a message diagram illustrating selection of a same set for a same UE/session context;

FIG. 3 is a message diagram illustrating instance registration with a control service node according to some embodiments of inventive concepts;

FIG. 4 is a message diagram illustrating set selection for a UE/session context according to some embodiments of inventive concepts;

FIG. 5 is a message diagram illustrating set selection for a UE/session context for dependent services according to some embodiments of inventive concepts;

FIG. 6 is a block diagram illustrating service A instances deployed in two sets (also referred to as groups) where a Service B selects one in each pool or a SPoA is provided for each pool according to some embodiments of inventive concepts;

FIG. 7 is a block diagram illustrating a set restoration storage resource according to some embodiments of inventive concepts;

FIG. 8 is a message diagram illustrating a set failure and access to a second set according to some embodiments of inventive concepts;

FIG. 9 is a block diagram illustrating a service instance set with a shared storage resource and an optional load balancer;

FIG. 10 is a block diagram illustrating a service instance set that spans across multiple data centers;

FIG. 11 is a block diagram illustrating a control service node according to some embodiments of inventive concepts;

FIG. 12 is a block diagram illustrating a service set instance node according to some embodiments of inventive concepts;

FIG. 13 is a block diagram illustrating a set restoration storage resource node according to some embodiments of inventive concepts;

FIGS. 14-16 are flow charts illustrating operations of a control service node according to some embodiments of inventive concepts;

FIGS. 17 and 18 are flow charts illustrating operations of a service instance set node according to some embodiments of inventive concepts;

FIG. 19 is a flow chart illustrating operations of a set restoration storage resource node according to some embodiments of inventive concepts.

### DETAILED DESCRIPTION

Embodiments will now be described more fully hereinafter with reference to the accompanying drawings. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

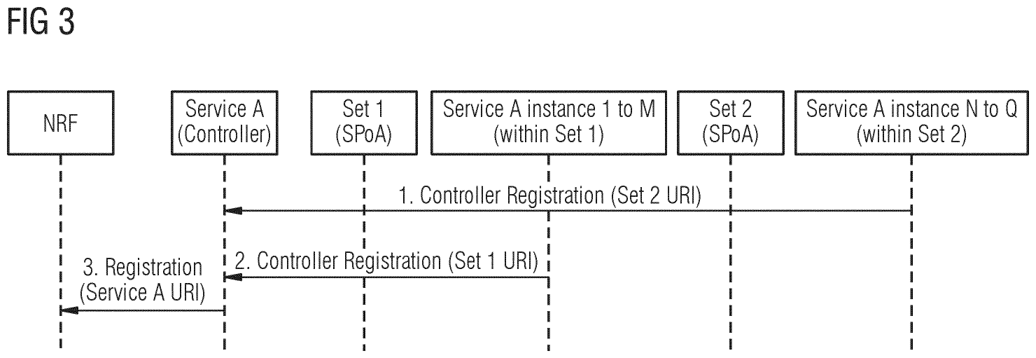

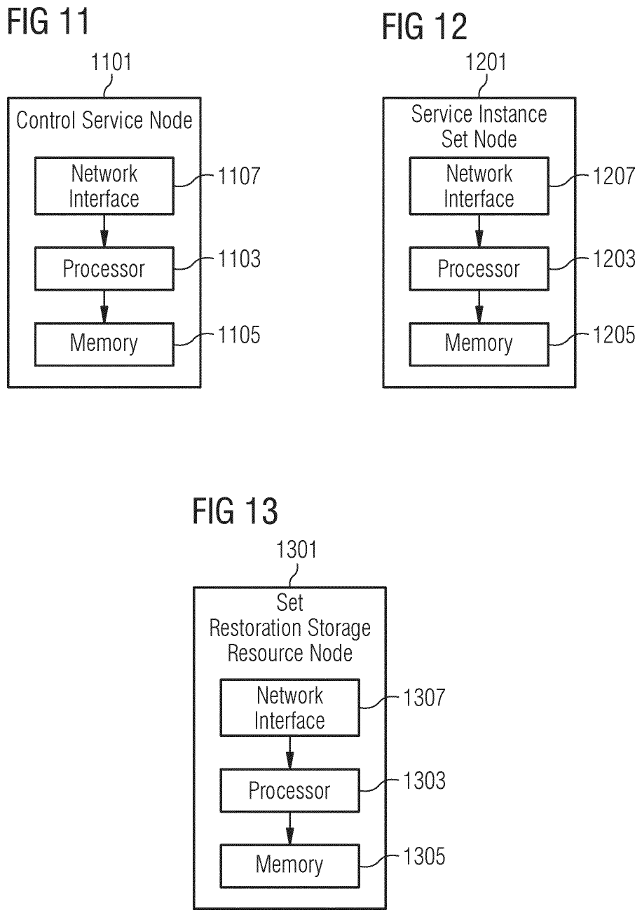

FIG. 11 is a block diagram illustrating elements of control service node/entity/function/server 1101 (referred to as a control service node) configured to support cellular communication according to some embodiments of inventive concepts. As shown, control service node 1101 may include a network interface circuit 1107 (also referred to as a network interface) configured to provide communications with other network nodes/entities/functions/servers. The network entity may also include a processor circuit 1103 (also referred to as a processor) coupled to the network interface circuit 1107, and a memory circuit 1105 (also referred to as memory) coupled to the processor circuit. The memory circuit 1105 may include computer readable program code that when executed by the processor circuit 1103 causes the processor circuit to perform operations according to embodiments disclosed herein (e.g., operations illustrated in FIGS. 3, 4, 5, 15, and/or 16, and/or operations discussed below with respect to respective example embodiments). According to other embodiments, processor circuit 1103 may be defined to include memory so that a separate memory circuit is not required.

As discussed herein, operations of the control service node 1101 may be performed by processor 1103 and/or network interface 1107. For example, processor 1103 may control network interface 1107 to transmit communications through network interface 1107 to one or more other network nodes/entities/functions/servers and/or to receive communications through network interface from one or more other network nodes/entities/servers. Moreover, modules may be stored in memory 1105, and these modules may provide instructions so that when instructions of a module are executed by processor 1103, processor 1103 performs respective operations. Operations of control service node 1101, for example, may be performed by one server or distributed across a plurality of network servers having the structure of FIG. 11, and a plurality of such distributed servers may be collectively referred to as a server. According to some embodiments control service node 1101 may be provided as a virtual control service node.

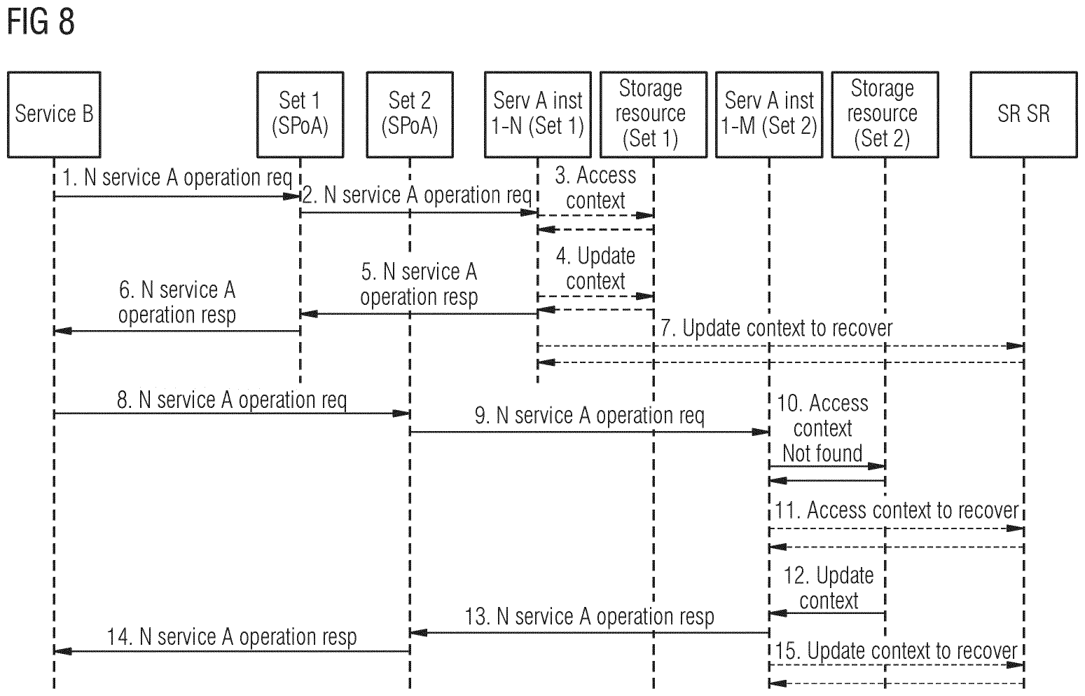

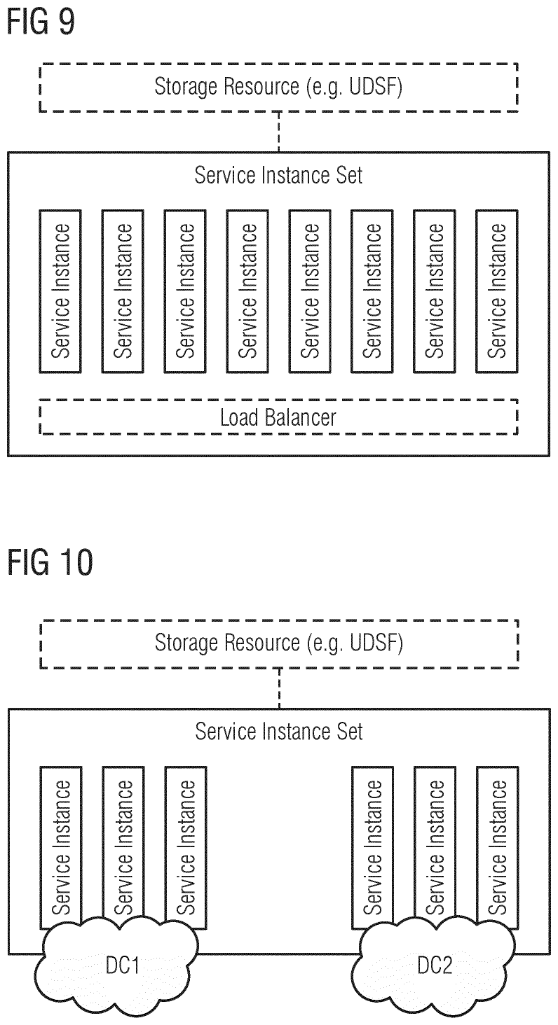

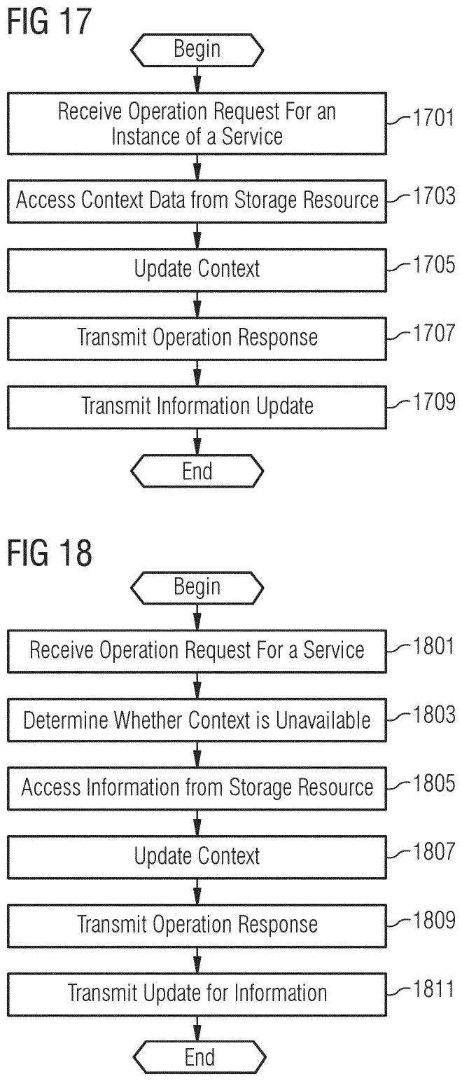

FIG. 12 is a block diagram illustrating elements of service instance set/node/entity/function/server 1201 configured to support cellular communication according to some embodiments of inventive concepts. As shown, service instance set 1201 may include a network interface circuit 1207 (also referred to as a network interface) configured to provide communications with other network nodes/entities/functions/servers. The network entity may also include a processor circuit 1203 (also referred to as a processor) coupled to the network interface circuit 1207, and a memory circuit 1205 (also referred to as memory) coupled to the processor circuit. The memory circuit 1205 may include computer readable program code that when executed by the processor circuit 1203 causes the processor circuit to perform operations according to embodiments disclosed herein (e.g., operations illustrated in FIGS. 8, 17, and/or 18 operations discussed below with respect to respective example embodiments). According to other embodiments, processor circuit 1203 may be defined to include memory so that a separate memory circuit is not required.

As discussed herein, operations of the service instance set 1201 may be performed by processor 1203 and/or network interface 1207. For example, processor 1203 may control network interface 1207 to transmit communications through network interface 1207 to one or more other network nodes/entities/functions/servers and/or to receive communications through network interface from one or more other network nodes/entities/servers. Moreover, modules may be stored in memory 1205, and these modules may provide instructions so that when instructions of a module are executed by processor 1203, processor 1203 performs respective operations. Operations of control service node 1201, for example, may be performed by one server or distributed across a plurality of network servers having the structure of FIG. 12, and a plurality of such distributed servers may be collectively referred to as a server. According to some embodiments service instance set 1201 may be provided as a virtual service instance set.

FIG. 13 is a block diagram illustrating elements of set restoration storage resource node/entity/function/server 1301 configured to support cellular communication according to some embodiments of inventive concepts. As shown, set restoration storage resource node 1301 may include a network interface circuit 1307 (also referred to as a network interface) configured to provide communications with other network nodes/entities/functions/servers. The network entity may also include a processor circuit 1303 (also referred to as a processor) coupled to the network interface circuit 1307, and a memory circuit 1305 (also referred to as memory) coupled to the processor circuit. The memory circuit 1305 may include computer readable program code that when executed by the processor circuit 1303 causes the processor circuit to perform operations according to embodiments disclosed herein (e.g., operations illustrated in FIGS. 8 and/or 19, and/or operations discussed below with respect to respective example embodiments). According to other embodiments, processor circuit 1303 may be defined to include memory so that a separate memory circuit is not required.

As discussed herein, operations of the set restoration storage resource node 1301 may be performed by processor 1303 and/or network interface 1307. For example, processor 1303 may control network interface 1307 to transmit communications through network interface 1307 to one or more other network nodes/entities/functions/servers and/or to receive communications through network interface from one or more other network nodes/entities/servers. Moreover, modules may be stored in memory 1305, and these modules may provide instructions so that when instructions of a module are executed by processor 1303, processor 1303 performs respective operations. Operations of set restoration storage resource node 1301, for example, may be performed by one server or distributed across a plurality of network servers having the structure of FIG. 13, and a plurality of such distributed servers may be collectively referred to as a server. According to some embodiments set restoration storage resource node 1301 may be provided as a virtual set restoration storage resource node.

While FIGS. 11-13 illustrates the structure of a control service node/entity/function/server, a service instance set/node/entity/function/server, and a set restoration storage resource node/entity/function/server, respectively, other network nodes/entities/functions/servers may have the same/similar structure including a network interface, a processor, and memory. As used herein, a node may be a virtual node, a service, entity, function, and/or server. For example, such a structure including a network interface, a processor, and memory may be used for a consumer node/entity/functions/server, producer node/entity/functions/server, network repository function node/entity/functions/server, single point of access node/entity/functions/server, load balancer node/entity/functions/server, storage resource node/entity/functions/server, service instance node/entity/functions/server, NRF service instance node/entity/functions/server, etc. A radio access network RAN node may be provided using a similar structure with a transceiver also coupled with the processor to provide wireless communication with one or more wireless devices (also referred to as UEs, User Equipment, User Equipment nodes, wireless terminals, etc.) over a radio interface.

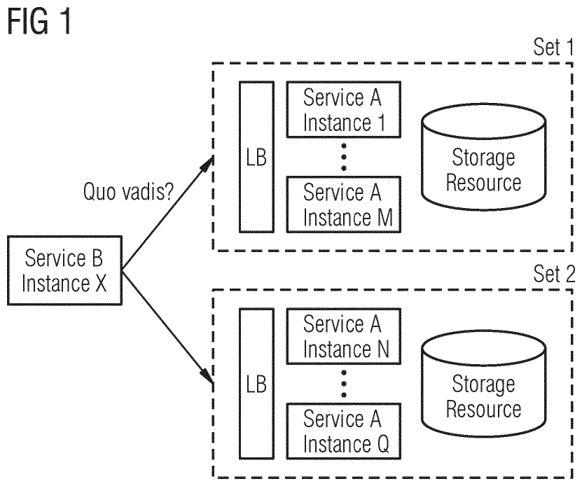

FIG. 1 is provided as an example, where instances of same Service A are deployed in two different Sets, i.e., there are two groups of instances (also referred to as sets of instances) that have access to different storage resources. FIG. 1 illustrates Service A deployed in two sets.

In FIG. 1, each set of instances may just offer one single point of access (e.g. a Uniform Resource Identifier, URI) to Service B (or any other consumer). As an example, a load balancer LB is included to reflect that, but other solutions may be possible, and this is not part of this disclosure.

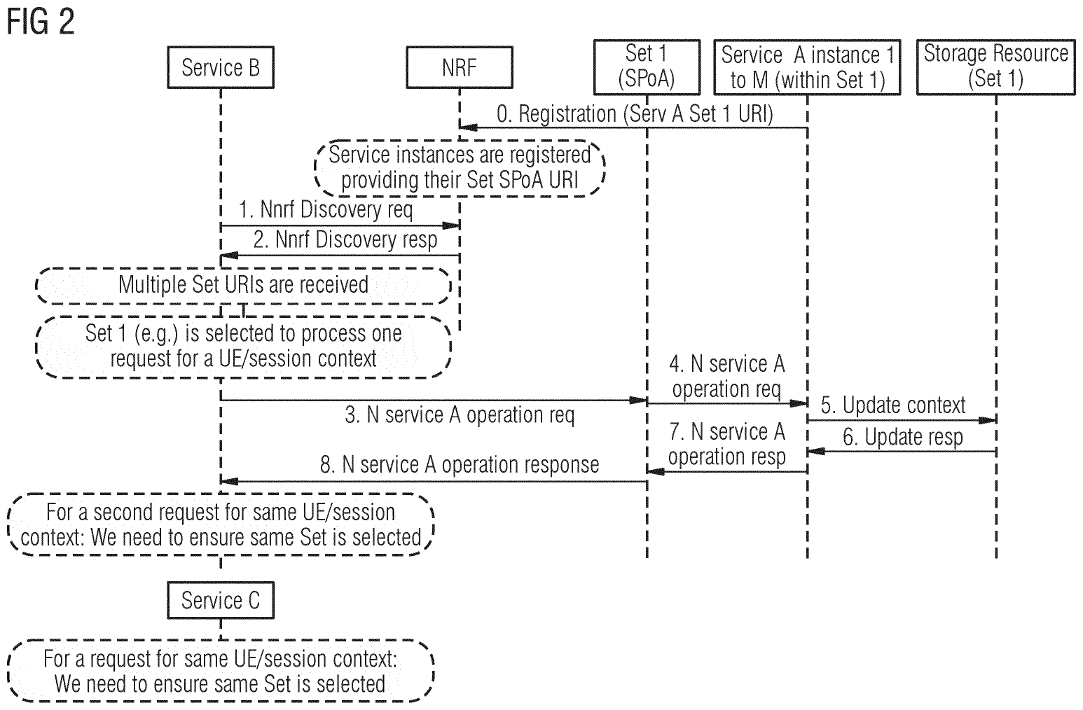

FIG. 2 illustrates a same set that may need to be selected for the same UE/session context. Operations of FIG. 2 are discussed below:
Operation 0. Service A instances registered to an NRF (also referred to as an NRF node/entity/function/server) providing a single URI for the whole Set. This may correspond to a LB or any other solution to hide the pool of instances. Set SPoAs (Single Points of Access) are displayed in the figure to ease understanding that the instances are not contacted directly by the end consumer, but via a SPoA for each Set.
Operation 1. Service B (valid a well for Service C, for any consumer of Service A) discovers Service A from the NRF.
Operation 2. Service B gets both Set 1 and Set 2 in the discovery response.
Operation 3. Service B selects one Set (either 1 or 2) to perform a Service A operation (e.g. a request) for a UE/session context (e.g. SUPI, PDU Session Id). Selection could be based in multiple criteria or even be random. In this example, Set 1 is selected, then Service B sends the Service A operation to the SPoA for Set 1.
Operation 4. The operation will reach one instance within the Set. This may be done by means of a LB that selects the less loaded instance.
Operation 5. The execution of the Service A operation may modify the UE/session context, that is then stored in the Storage Resource that is deployed for Set1.
Operation 6. Response of the update operation
Operations 7 and 8. Response of the Service A operation

Then, a subsequent operation by Service B for the same UE/session context shall reach same Set. If a different Set is selected, this new operation may not take into account updated context by previous operation. This situation may be quite frequent, e.g. the AMF (also referred to as an AMF node/entity/functions/server) receives different interaction from the same UE (also referred to as a wireless device), for same or different DNN and NSSAI, then same or different PDU Sessions are created/selected . . . those values may identify a context that is modified and kept in the Storage Resource within the Set, that defines and state.

The same applies to any other Service (e.g. service C) that may be required to operate on the same UE/session context. This is as well quite frequent, e.g. for Exposure services, for Rel-15, each/most NFs have defined an Exposure service, that may be required to provide access to other NFs to the data that is managed by the NF (also referred to as an NF node/entity/functions/server), then the Exposure service should access data that is owned and manipulated by other NF services. Another example, some services allow an external service to subscribe to receive notifications upon certain events/updates, then the external service should send this subscription to the same Set (i.e. the exact same service (or group of services) that are able to access the same Storage Resource).

Apart from that, in the context of the eSBA TR (ref [3]) there may be a requirement to achieve an independent management per each service, but sometimes this may not be possible as long as some defined services (in Rel-15) have some common data, that is accessed internally by implementation dependent interfaces. But, even though in Rel-15 some services are defined with those dependencies, how to provide operation on that shared data (by multiple services, at least two) may be unresolved.

In summary, it may be desirable to provide operations on the same UE/session context by accessing the same Storage Resource.

Some embodiments herein may provide a new element named Service producer controller or control service node that acts as a Front-End of the multiplicity of service producer instances in the system/network/deployment. There may be only one single logical Service producer controller, but this does not preclude multiple instances being defined and hidden by e.g., a load-balancer or a DNS-based resolution service.

In the following disclosure, the term “Storage Resource Group” is used to refer to all the consumer instances that may be required to use the same Storage Resource, to be able to provide access to shared data, i.e. all consumer instances within a Set or within a Deployment Unit.

According to some embodiments disclosed herein, the Sets of instances may be registered to the new Controller (instead of to the NRF), while the Controller registers itself to the NRF with a single URI.

Then the Controller may keep track of registered Sets and their availability and may select the very same Set for the operations that may be required to access the same UE/session context, in order to provide that the operations always access the fresh updated data.

Procedures proposed in the present disclosure are described with the following call flows.

FIG. 3 illustrates a new registration to the controller.

A change is that only one SPoA, one URI is registered in the NRF as providing Service A, while each Set may need to register to the Controller rather than to the NRF. This is explained with respect to FIG. 3, where numbered operations do not need to go in any order, just numbered to ease description. Operations of FIG. 3 are discussed below:
Operation 1. Instances M to Q or service A are deployed in a Set (pool) offering as a single URI (e.g. of a LB). All the instances within the Set register a single URI is in the Controller entity as the SPoA for Set 2. This registration may be referred to as “Controller Registration” since it is not the existent registration in the NRF, however, the mechanism is similar.
In fact, the service instances do not need to know whether they register to the NRF or to a Controller, they could use exactly the same procedures and messages. In this sense this does not need to be standardized. This may allow inclusion in a deployment using a Controller by Ericsson, while the Service instances are by another vendor.
Operation 2. Similar to operation 1 for instances within Set 1.
Operation 3. Only one single URI is registered for Service A, this corresponds to the entity that acts as the controller for this Service A. Multiple instances of the controller could be instantiated, and then a single URI could be offered in the say way as for the Sets.
The controller registers into the NRF exactly as if it were a regular service A instance, then standardization may not be required.
Therefore, an Ericsson Controller could be included without any standardization need.

In the following call flow, there is a Service Instance Set (SIS) of the consumer service, and two different SISs for the service producer.

For the SIS consumer, the Storage Resource is included in the figure, that has been omitted for simplicity in SIS1_Producer and SIS2_Producer. Moreover, for the SIS Producers a SPoA is offered, by e.g. a LB, this is equally excluded from the figure.

In the figure, it is considered optional the existence of a separated Storage Resource as an independent and external service. This is why the interactions with this element are marked as optional (dotted lines).

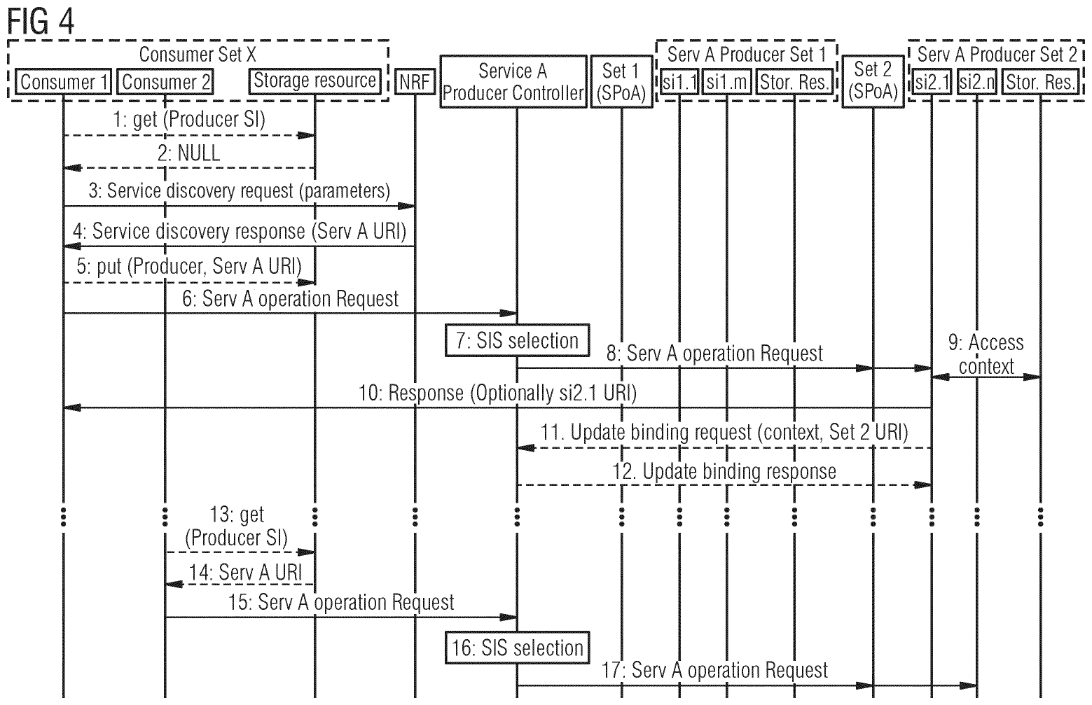

FIG. 4 illustrates Selection of the right Set for a UE/session context. Operations of FIG. 4 are discussed below:
Operation 1. Consumer 1 wants to send a request to Service A (producer), and then it first checks if the right address to use to contact that service is stored from a previous interaction.
Operation 2 In this example, the address is not stored.
Operation 3. Then the consumer needs to discovery the means to contact Service A.
Operation 4. Discovery response includes the Serv A URI. This corresponds to the “Serv A producer controller”, but from a consumer perspective the “Serv A producer controller” is just a Service A.
Operation 5. The consumer may store the Service A URI in the Storage Resource.
Operation 6. Consumer sends a Serv A operation request to the Service A, using the URI received that corresponds to the “Serv A Producer Controller”
Operation 7. The Controller receives the Service A operation request, and needs to select to which Set of instances it is sent. First, it must check if there is a Set already assigned to the corresponding UE/session context. The UE/session context shall be included in the Service A operation request, today it is considered an HTTP/REST interface, then it should be included in the HTTP body. E.g. if the operation is for SUPI-Y and for PDU Session Id-X, this should be included in the request. Then, the Controller reads the request and needs to know which parameters should be used to identify a UE/session context, e.g. SUPI and PDU Session. Then based on those, it checks if there is already a Set assigned, checking a mapping that has to be kept in permanent memory (either internal or external).
If a Set is already assigned to that UE/session context, then the same Set is selected. If there is not a Set assigned yet, then the Controller selects one from the available ones (in this case Set 1 and Set 2). The selection could be based on different criteria, e.g. load. Then, the controller keeps record of this assignment in permanent memory.
Operation 8. The controller forwards the Service A operation request to the selected Set (in this case Set 2 SPoA) using registered URI. The forwarded request includes the URI of the consumer. Set 2 SPoA chooses one instance within this Set, this selection could be based in different criteria (e.g. load). Corresponding Service A instance executes the request using the stored UE/session context in its Set Storage Resource.
Operation 9. The instance receiving the operation request accesses the stored context in order to be able to process the request. It may also need to manipulate part of the stored context.
Operation 10. The Service A operation response is sent back to the consumer (either directly, as in the figure, or through the Set 2 SPoA). It may optionally include the URI of the specific instance within the Set that has managed the request, that could be used to minimize extra hops and establish a direct communication during the same procedure execution flow.
Operations 11 and 12. In case this UE/session context is created or deleted, then the Controller has to either create or delete the corresponding mapping, in this case it is relevant that only when the operation has successfully performed the affected service instance informs back to the Controller.
Operation 13. In a later stage, another consumer instance within the same Consumer Set wants to send a request to Service A, then it first checks whether for that Service A a contact URI is already available.
Operation 14. In this case, the Service A URI is available (it was stored in operation 5), then it is provided to the consumer instance 2.
Operation 15. Consumer instance 2 sends a Service A operation using stored URI, that corresponds to the Controller.
Operation 16. The Controller needs to select a Set. It needs to read corresponding parameters received in the request to be able to identify the UE/session context, and then check if it has already stored a mapping to any Set. In this case, this mapping has been stored in operation 11 (when it was created), then Set 2 (SPoA) is selected.
Operation 17. As in Operation 8, the Controller forwards the request to Set 2 SPoA, which chooses one instance within this Set, this selection could be based in different criteria (e.g. load).

As explained above, in the context of the eSBA TR (ref [3]) there may be a requirement to achieve an independent management per each service, but sometimes this may not be possible as long as some defined services (in Rel-15) have some common data, that is accessed internally by implementation dependent interfaces.

A possible solution for that problem is to not consider those services as independent from a management perspective, but fit those into a group. For example, if Service A and Service B have some data in common, (they are dependent to each other processing and updating of internal UE/session context), then they can be defined to be deployed always together as part of what may be referred to as a “Deployment Unit” DU.

This deployment unit may be provided in two or more instances of different service types, that then are deployed together and are single vendor. Since the Service instances within the deployment unit share some data, they need to access same Storage Resource, and this may be addressed according to some embodiments disclosed herein.

A similar solution to what is described above applies, with some modifications as explained in following call flow.

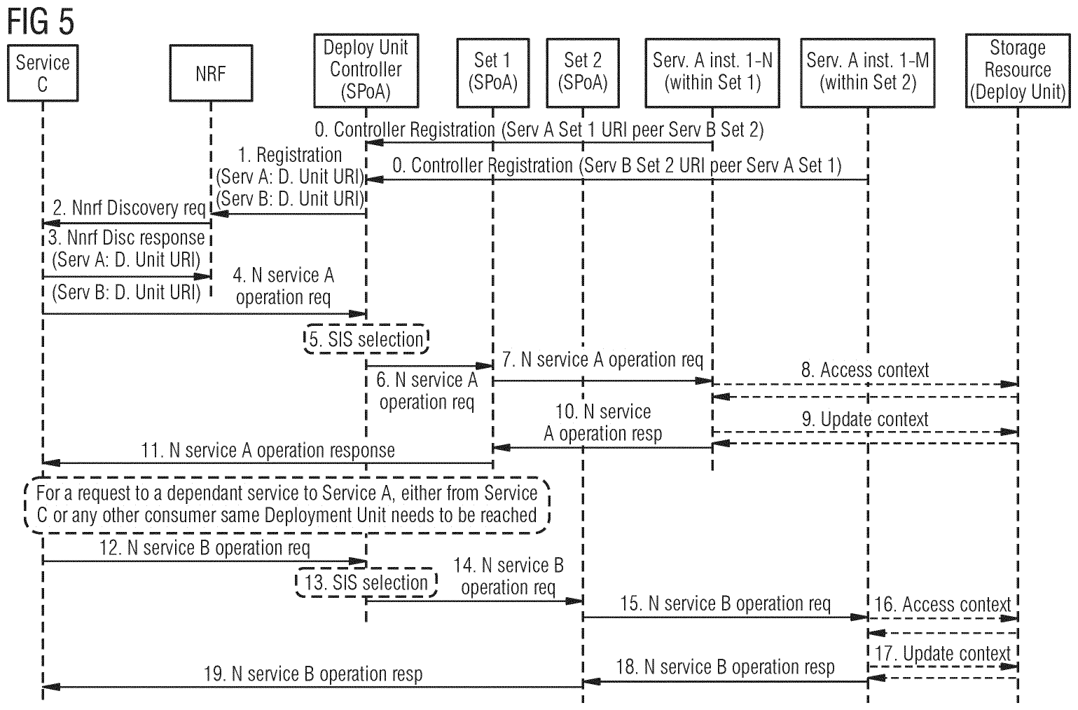

FIG. 5 illustrates selection of the right Set for a UE/session context for dependent services. Operations of FIG. 5 are discussed below:
Operation 0. Similar to operation 1 in FIG. 3 above. The difference is that now the Controller acts as a controller for the whole Deployment Unit (DU), that involves two or more dependent services. Then, the controller keeps track of what services belong to the DU, and which Sets serve each service.
Another difference may be that in order to provide that both Service A and B have access to the same Storage Resource, a deployment requirement may be defined: same Storage Resource must be shared by at least one Set of the dependent services (A and B in our example). Then Service A Sets are peered with Service B Sets (peered Set access to the same Storage Resource). Information about Set peers is provided at Controller Registration, e.g., in a form of naming conventions in the set URIs.
Operation 1. DU Controller registers only its URI into the NRF, as the serving URI for all the services that belong to the DU. In this example, for Services A and B.
Operations 2 and 3. Service C wants to contact Service A, then it has to get its URI by NRF discovery. The DU URI is provided back for Service A. If Service C wants to use as well Service B (in operation 11), then same DU URI is provided.
Operation 4. Service C sends a Service A operation to the corresponding DU URI.
Operation 5. The DU controller needs to perform similar checks as in previous FIG. 4, operation 7, plus something else. In this case, the DU controller could receive requests for multiple services (A and B), that are identified by the same URI, while in the former case the URI of the Controller only identifies one single Service. Then, DU Controller needs to identify the right service name (in the request), to forward the request to the right Set.
Operations 6 to 11 are similar to FIG. 4, operations 8 to 10. FIG. 4 operations 11 and 12 may be applicable in this case as well, not included in the figure for simplicity. Operation 12. Service C wants to execute a Service B operation, that is dependent to Service A. Then it sends the request to the URI received at discovery (operation 3), that corresponds to the same DU Controller.
Operation 13. The Controller performs same tasks as in FIG. 4, operation 16. The important difference is that in this case, the controller needs to select the Set for Service B (for the corresponding UE/session context) based on the assigned Set for dependent Services (in this case Service A). Only a peered Set could be selected, in order to have access to the same Storage Resource.
Operations from 14 to 19. They are similar to operations 6 to 11 in this flow.

Some embodiments of inventive concepts disclosed herein may provide one or more of the following advantages:
In the case of services (e.g. A and B) that have some dependencies (i.e., they share data), that are defined as a group (Deployment Unit), some embodiments may provide a solution to be able to access from the different services within the Deployment Unit to the same Storage Resource. This may allow that the Deployment Unit has independent LCM.
Some embodiments may provide that operations on the same UE/session context access the same Storage Resource, where this UE/session context is stored. Otherwise, any transaction that requires information about the current state may not work (and in 5GC most, if not all, transactions may be required to continue from a previous state).
Some embodiments may not impose any constraints on how the services are organized in sets and how the sets are scaled, and also may allow use of other methods to shorten the communication latency, e.g., based on direct communication between the service instances.

As discussed with respect to FIGS. 3-5, 11, 14, 15, and 16, herein, a control service node (also referred to as a service producer controller and/or a service controller node) may act as a front end of a multiplicity of service producer instances (also referred to as service instance sets or service instance set nodes). There may only be one single logical Service producer controller, but this does not preclude multiple instances from being defined and hidden by e.g., a load-balancer or a DNS-based resolution service.

Instead of registering the Sets of instances to the NRF, the Sets of instances can be registered to the new Controller (service controller node), which registers itself to the NRF with a single URI. Then the Controller keeps track of registered Sets and their availability, and selects the very same Set for the operations that require to access the same UE/session context, in order to ensure that the operations always access the fresh updated data.

Operators may require that even though the instances within a Set could be by a single vendor, there may be multiple Sets (for the same service type) by different vendors. One concern is that a service provided by a Set that is supported by one vendor may become unavailable (e.g., failure, maintenance . . . ) and another Set supporting the service may be provided by another vendor.

This may require providing a way for a consumer to continue using a service when a new producer of Set1 (a first service instance set) takes over a former producer Set2 (a second service instance set). Potentially Set1 and Set2 are by different vendors.

Taking into account that each Set may own a Service Storage Resource as described with respect to FIG. 1 above, it may be desirable to provide a way to store required context data/information in the new Service Storage Resource.

Some embodiments herein may provide a definition of a Set Restoration Storage Resource (SRSR), that is, a storage node that is common for all the service instances for the same Service type, even though they may be deployed in multiple Sets (by same or different vendors). The SRSR may be used in cases when there is a need for context transfer and recovery to a different Set (e.g. whole Set maintenance, whole Set upgrade, Set failure, . . . ) and the SRSR may store information needed to achieve this context transfer. The information stored may include data to re-build a certain context and may include information about the service instance recently updating the data.

The service instance functionality may be extended to store data in the SRSR that is needed to transfer the context. The service instances may also request this data from the SRSR when the relevant data is unavailable in the local Storage Resource.

According to some embodiments, the following advantages may be provided:
Operators' requirements to deploy multiple Sets (for the same service type) by same or different vendors may be supported.
Access to the context from an alternative Set2 (for the same service type) may be provided in case Set1 is unavailable for any reason (e.g. maintenance, upgrade, Set failure . . . ). By this,
   A vendorX Service may be allowed to be upgraded while other vendorY keeps providing service.
   A critical failure (by a vendor) that may affect a service in a network may be avoided, provided that another vendor service could be used.
The normal service operation may be decoupled from the cases where context needs to be handled by alternative sets. The overall service performance may be improved and/or can reduce/minimize accessing the central data storage during normal operation.
The SRSR may qualify as a database (DB) to be provided by CNA infrastructure, which may be a preference by operators.

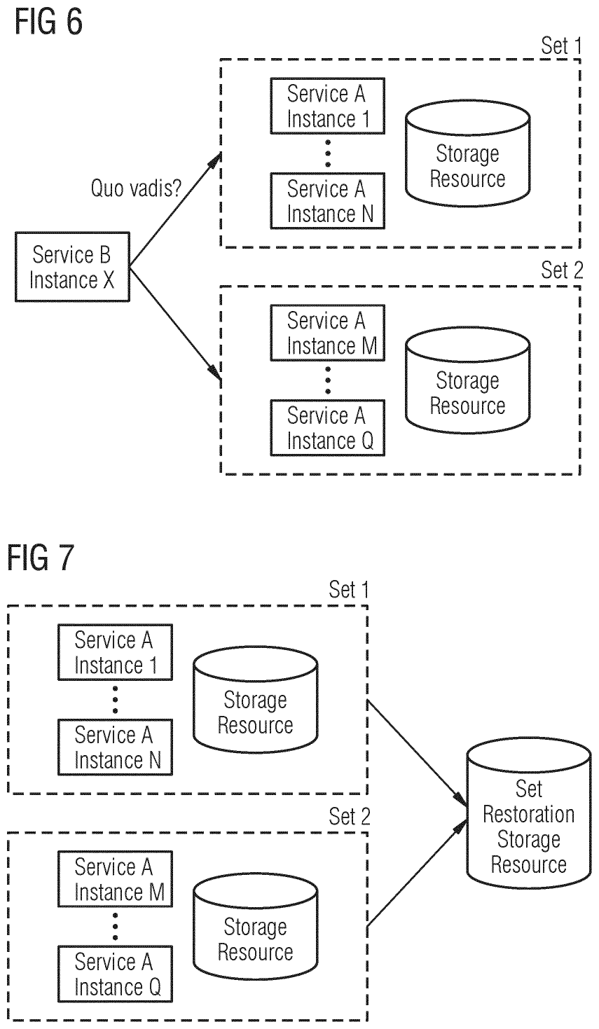

FIG. 1 could be updated to reflect that it is not only possible to provide a SPoA in front of the pool of instances, but alternatively the consumer may select one from the pool. This is a more general case that is discussed with respect to FIG. 6.

FIG. 6 illustrates Service A instances deployed in two Sets where either service B selects one Set in each pool or a SPoA is provided for each pool

Some embodiments may provide the definition of a Set Restoration Storage Resource (SRSR), that is, a storage node that is common for all the service instances for the same Service type, even though they may be deployed in multiple Sets (by same of different vendors), as illustrated by FIG. 7, which illustrates a New Set Restoration Storage Resource.

The SRSR may need to span multiple DC (Data Centers) in order to provide Geo redundancy support.

The SRSR may be a specific database DB for each Service, or all the data required to be stored by a group of (or all) the services deployed in a network may use the same DB.

The context data that is stored in the SRSR and that is expected to be recovered may be standardized so that the context data is understood by different vendor service instances. The SRSR may be considered part of 5GC UDR, and the standardized context data may be defined as data to be stored in 5GC UDR. For this to occur, a new Data Set may be defined and then Nudr may be used. But as an alternative, the SRSR may be considered to be an independent DB, and then decision about the interface will be taken in 3GPP stage 3.

FIG. 8 shows an example sequence diagram depicting a scenario where an alternative Set 2 is used when former Set 1 is considered unavailable.

Operations of FIG. 8 (providing access to service instruction set 2 after failure of service instruction set 1) are discussed below.
Operation 1. Service B (a consumer of service A) requests a Service A operation. For that it sends an operation to the Address received at Registration. The address in this example is of Set 1 where the corresponding context is stored.
Operation 2. Operation request reaches one instance of Set 1 through Set 1 SPoA. Any instance of Set 1 is potentially reachable, one instance in the Set may be selected based on different criteria (e.g. load).
Operation 3. The context may be accessed from the local resource storage.
Operation 4. Based on the operation requested, the context may be updated.
Operations 5-6. Successful response back.
Operation 7. The context that may be needed for potential recovery at a distinct service set may be updated in the SRSR. Note that this update does not delay the execution of the service operation because it follows the operation response of operation 5.
Operation 8. After some time, another service A operation may be requested for the same context.
Operation 9. The operation request may reach Set 2 instead of Set 1 e.g., due to unavailability of Set 1. This could be achieved by Set selection at service B, or by other means.
Operation 10. Context data may be attempted to be accessed from local resource storage but not found (since the context is owned by Set 1).
Operation 11. Context data may be accessed from the SRSR. New instance of Service A in Set 2 may execute its business logic using this data. That is, state may be recovered from that last Context stored. Note that at this stage the service A instance may be able to discover the original owner of the context (Set 1) (i.e. the context has been stored from another Set of instances, this information may be provided in operation 7) and may trigger different actions due to that the context has been recovered. This could be used for e.g., updating the context bindings in other services.
Operation 12. As a result of Service A operation execution, the Context may be modified, and this may be updated in the local resource storage of Set 2.
Operations 13, 14. Successful response back.
Operations 15. The part of context that may be needed for potential recovery at a distinct service set may be updated in the SRSR.

The separation of service logic and data, which may be an assumption for some embodiments described herein, may facilitate applying cloud-native design principles for services in the SBA domain.

In order to be able to support multi vendor service instances of the same service type, and be able to recover network service, some embodiments described herein may store context data in a standardized way and in a common storage for all those instances (SRSR), even though service instances may be from a different vendor, and then provide a way to support reaching an alternative Set2 when Set1 is not reachable. The proposal is based on a central storage for the data that may need to be accessed, but in a way that the interaction with this storage is reduced, and so its impact on the overall network performance may be reduced.

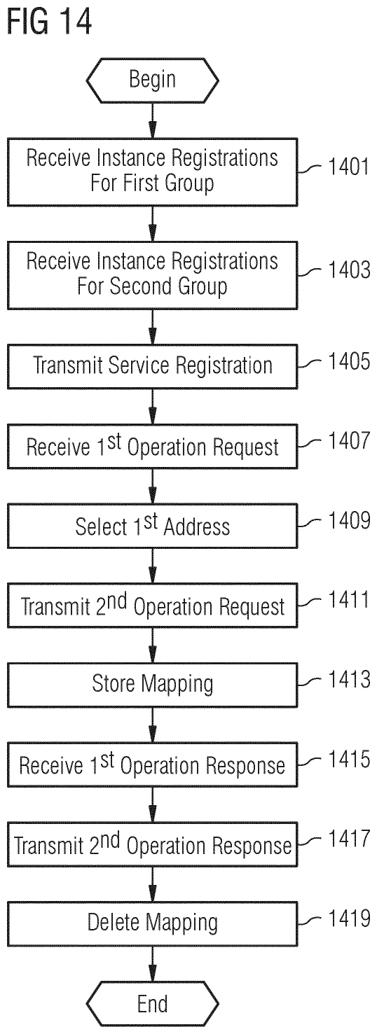

Operations of control service node/entity/function/server 1101 (also referred to as a service controller node) will now be discussed with reference to the flow chart of FIG. 14 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 14.

At block 1401, processor 1103 may receive (through network interface 1107) instance registrations for respective instances of a first group of instances of a service provided within the communication network, and each of the instance registrations for the instances of the first group may include a same first address. Operations of block 1401 may be performed as discussed above with respect to operation 1 of FIG. 3.

At block 1403, processor 103 may receive (through network interface 1107) instance registrations for respective instances of a second group of instances of the service provided within the communication network, and each of the instance registrations for the instances of the second group may include a same second address, with the first and second addresses being different. Operations of block 1403 may be performed as discussed above with respect to operation 2 of FIG. 3.

At block 1405, processor 1103 may transmit (through network interface 1107) a service registration for the first and second groups of instances of the service to a registration node, with the service registration being transmitted based on receiving the instance registrations for the first and second groups of instances. The service registration may include a service address, with the service address being different than the first address, and with the service identifier being different than the second address. Operations of block 1405 may be performed as discussed above with respect to operation 3 of FIG. 3.

At block 1407, processor 1103 may receive (through network interface 1107) a first operation request for the service from a consumer node of the communication network, wherein the first operation request includes the service address and a context for a device, session, and/or subscription. Operations of block 1407 may be performed as discussed above with respect to operation 6 of FIG. 4.

At block 1409, processor 1103 may select the first address responsive to receiving the operation request for the service. Operations of block 1409 may be performed as discussed above with respect to operation 7 of FIG. 4.

At block 1411, processor may transmit a second operation request for the service from the control service node to an access (SPoA) node for the first group of instances of the service responsive to selecting the first address. The second operation request may include the first address and the context for the device, session, and/or subscription. Operations of block 1411 may be performed as discussed above with respect to operation 8 of FIG. 4. At block 1413, processor may store a mapping between the context and the first address, for example, based on the selecting of block 1409.

At block 1415, processor 1103 may receive (through network interface 1107) a first operation response from an instance of the first group of instances, with the first operation response corresponding to the second operation request, and with the first operation response relating to the context for the device, session, and/or subscription. Operations of block 1415 may be performed as discussed above with respect to operation 10 of FIG. 4.

At block 1417, processor 1103 may transmit (through network interface 1107) a second operation response to the consumer device, with the second operation response corresponding to the first operation response, and with the second operation response relating to the context for the device, session, and/or subscription. Operations of block 1417 may be performed as discussed above with respect to operation 10 of FIG. 4.

At block 1419, processor 1103 may delete the mapping between the context and the first address responsive to the first operation response of block 1415 including an indication of deletion of the context.

According to some other embodiments, operation responses may be transmitted directly from instances to consumer nodes bypassing the control service node, so that operations 1415, 1417, and 1419 may be omitted. In such embodiments, processor 1103 may receive (through network interface 1107) a request from an instance of the first group of instances, with the request including an indication of deletion of the context. Responsive to receiving such a request, processor 1103 may delete the mapping between the context and the first address. Such operations are discussed above with respect to operation 11 of FIG. 4.

Various operations from the flow chart of FIG. 14 may be optional with respect to some embodiments of control service nodes and related methods. Regarding methods of some embodiments, for example, operations of blocks 1407, 1409, 1411, 1413, 1415, 1417, and 1419 of FIG. 12 may be optional.

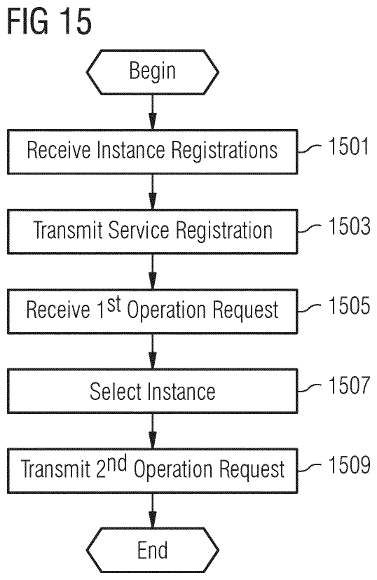

Operations of control service node/entity/function/server 1101 will now be discussed with reference to the flow chart of FIG. 15 according to some embodiments of inventive concepts. For example, modules may be stored in memory 1105 of FIG. 1, and these modules may provide instructions so that when the instructions of a module are executed by processor 1103, processor 1103 performs respective operations of the flow chart of FIG. 15.

At block 1501, processor 1103 may receive (through network interface 1107) instance registrations for respective instances of a service provided within the communication network. At block 1503, processor 1103 may transmit (through network interface 1107) a service registration for the instances of the service to a registration node, with the service registration being transmitted based on receiving the instance registrations, with the service registration including a service address, and with the service address being different than instance addresses of the respective instances. At block 1505, processor 1103 may receive (through network interface 1107) a first operation request for the service from a consumer node of the communication network, with the first operation request including the service address and a context for a device, session, and/or subscription. At block 1507, processor 1103 may select a respective one of the instances of the service responsive the operation request for the service. At block 1509, processor 1103 may transmit (through network interface 1107) a second operation request for the service from the control service node to the instance selected responsive to the operation request, with the second operation request including the context for the device, session, and/or subscription.

Various operations from the flow chart of FIG. 15 may be optional with respect to some embodiments of control service nodes and related methods.

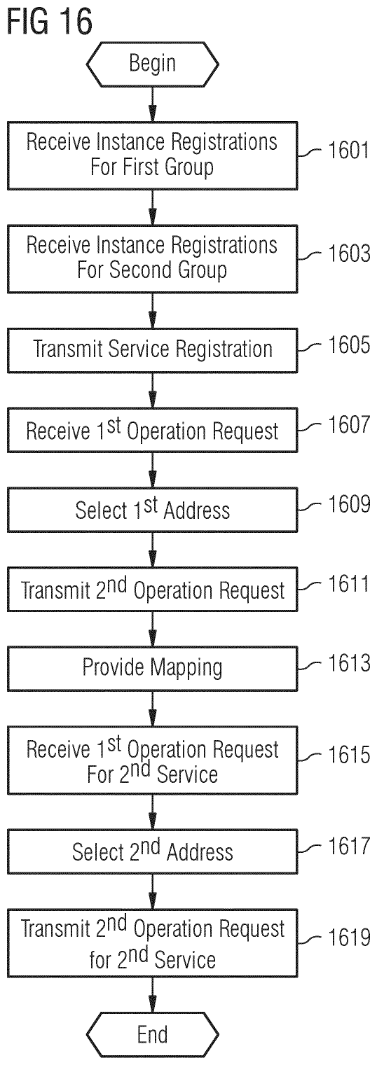

Operations of control service node/entity/function/server 1101 will now be discussed with reference to the flow chart of FIG. 16 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 14.

At block 1601, processor 1103 may receive (through network interface 1107) instance registrations for respective instances of a first group of instances of a first service provided within the communication network. Each of the instance registrations for the instances of the first group may include a first address. Operations of block 1601 may be performed as discussed above with respect to operation 0 of FIG. 5.

At block 1603, processor 1103 may receive (through network interface 1107) instance registrations for respective instances of a second group of instances of a second service provided within the communication network. Each of the registrations for the instances of the second group may include a second address, the first and second addresses may be different, and the first and second services may be different. Operations of block 1603 may be performed as discussed above with respect to operation 0 of FIG. 5.

At block 1605, processor 1103 may transmit a service registration for the first and second groups of instances, wherein the service registration is transmitted based on receiving the instance registrations for the first group of instances and the second group of instances. The service registration may include a service address, the service address may be different than the first address, and the service address may be different than the second address. Operations of block 1605 may be performed as discussed above with respect to operation 1 of FIG. 5.

At block 1607, processor 1103 may receive (through network interface 1107) a first operation request for the first service from a consumer node of the communication network. The first operation request may include the service address and a context for a device, session, and/or subscription. Operations of block 1607 may be performed as discussed above with respect to operation 4 of FIG. 5.

At block 1609, processor may select the first address responsive to receiving the first operation request for the first service. Operations of block 1609 may be performed as discussed above with respect to operation 5 of FIG. 5.

At block 1611, processor 1103 may transmit (through network interface 1107) a second operation request for the first service from the control service node to an access node for the first group of instances of the first service responsive to selecting the first address. The second operation request may include the first address and the context for the device, session, and/or subscription. Operations of block 1611 may be performed as discussed above with respect to operation 6 of FIG. 5.

At block 1613, processor 1103 may provide a mapping between the context and the first address and the between the context and the second address responsive to selecting the first address.

At block 1615, processor 1103 may receive (through network interface 1107) a first operation request for the second service. The first operation request for the second service may include the service address and the context for the device, session, and/or subscription. Operations of block 1615 may be performed as discussed above with respect to operation 12 of FIG. 5.

At block 1617, processor 1103 may select the second address responsive to receiving the first operation request for the second service. Processor 1103, for example, may select the second address based on the mapping of block 1113. Operations of block 1617 may be performed as discussed above with respect to operation 13 of FIG. 5.

At block 1619, processor 1103 may transmit (through network interface 1107) a second operation request for the second service from the control service node to an access (SPoA) node for the second group of instances of the second service responsive to selecting the second address. The second operation request may include the second address and the context for the device, session, and/or subscription. Operations of block 1619 may be performed as discussed above with respect to operation 14 of FIG. 5.

Various operations from the flow chart of FIG. 16 may be optional with respect to some embodiments of control service nodes and related methods. Regarding methods of some embodiments, for example, operations of blocks 1607, 1609, 1611, 1613, 1615, 1617, and 1619 of FIG. 16 may be optional.

According to some embodiments, the control service node may be collocated in a Unified Data Management UDM node and/or a UDR node so that embodiments herein may be performed in the UDM and/UDR node. In such embodiments as applied to FIG. 3, for example, the controller registrations of operations 1 and 2 may be replaced by a registration/update of information in the UDM and/or Unified Data Repository UDR.

According to some embodiments, a service instances may not need to register an SPoA for the respective set, but instead, the service instances may register each individual address in the control service node. The control service node may then select one of the instances within the set based on different criteria (e.g., load). In such embodiments, a separate SPoA may not be needed for the set, and it may be up to the control service node to perform selection of any instance within the set.

According to some embodiment, mapping may not be required. For example, the control service node may be able to uniquely identify a corresponding set based on parameters (e.g., context) received (e.g., by a hash).

Operations of service instance set node/entity/function/server 1201 will now be discussed with reference to the flow chart of FIG. 17 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 17.

At block 1701, processor 1203 may receive (through network interface 1207) an operation request for an instance of the service in the service instance set. The service instance set may include a plurality of instances of the service. The operation request may include a context identifier. The context identifier may be associated with a device, a session, and/or a subscription. The operation request may be received from a consumer node through an access node in some embodiments. The operation request received from the consumer node may be received through the access node. In other embodiments, the operation request may be received from a consumer node without an intervening access node. Operations of block 1701 may be performed as discussed above with respect to operation 2 of FIG. 8.

At block 1703, processor 1203 may access (through network interface 1207) context data from a storage resource for a context associated with the context identifier using the instance of the service. Operations of block 1703 may be performed as discussed above with respect to operation 3 of FIG. 8.

At block 1705, processor 1203 may update the context at the storage resource using the instance of the service responsive to receiving the operation request. Operations of block 1705 may be performed as discussed above with respect to operation 4 of FIG. 8.

At block 1707, processor 1203 may transmit (through network interface 1207) an operation response after updating the context at the storage resource. The operation response may include the context identifier. The operation response may be responsive to the operation request. The operation response may be transmitted through the access node. When the operation request is received from the consumer node, the operation response may be transmitted to the consumer node. In some embodiments, the operation response is transmitted to the consumer node through the access node. Operations of block 1707 may be performed as discussed above with respect to operation 5 of FIG. 8.

At block 1709, processor 1203 may transmit (through network interface 1207) an update for information relating to a context associated with the context identifier to a set restoration storage resource node using the instance of the service responsive to receiving the operation request. In some embodiments, the update may be transmitted after the operation response is transmitted. Operations of block 1709 may be performed as discussed above with respect to operation 7 of FIG. 8.

Various operations from the flow chart of FIG. 17 may be optional with respect to some embodiments of service instance set nodes and related methods. Regarding methods of some embodiments, for example, operations of blocks 1703, 1705, and 1707 of FIG. 17 may be optional.

Operations of a service instance set node/entity/function/server 1201 for a service of a communication network will now be discussed with reference to the flow chart of FIG. 18 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 18.

At block 1801, processor 1203 may receive (through network interface 1207) an operation request for a service from a consumer node. The service instance set may include a plurality of instances of the service. The operation request may include a context identifier. The context identifier may be associated with a device, a session, and/or a subscription. The operation request may be received from a consumer node through an access node in some embodiments. The operation request received from the consumer node may be received through the access node. In other embodiments, the operation request may be received from a consumer node without an intervening access node. Operations of block 1801 may be performed as discussed above with respect to operation 9 of FIG. 8.

At block 1803, processor 1203 may determine whether a context associated with the context identifier is unavailable from a storage resource associated with the service instance set. Operations of block 1803 may be performed as discussed above with respect to operations 10 of FIG. 8.

At block 1805, processor 1203 may access information relating to the context from a set restoration storage resource responsive to determining that a context associated with the context identifier is unavailable from a storage resource associated with the service instance set. Operations of block 1805 may be performed as discussed above with respect to operation 11 of FIG. 8.

At block 1807, processor 1203 may update the context at the storage resource associated with the service instance set responsive to receiving the operation request and responsive to receiving the information relating to the context from the set restoration storage resource. Operations of block 1807 may be performed as discussed above with respect to operation 12 of FIG. 8.

At block 1809, processor 1203 may transmit (through network interface 1207) an operation response after updating the context at the storage resource. The operation response may be responsive to the operation request. The operation response may include the context identifier. The operation response may be transmitted through the access node to the consumer node. When the operation request is received from the consumer node, the operation response may be transmitted to the consumer node. In some embodiments, the operation response is transmitted to the consumer node through the access node. Operations of block 1809 may be performed as discussed above with respect to operation 13 of FIG. 8.

At block 1811, processor 1203 may transmit (through network interface 1207) an update for information relating to the context to the set restoration storage resource node based on the operation request. Transmitting the update to the set restoration storage resource node may occur after transmitting the operation response. In some embodiments, the update is transmitted after the operation response of block 1809 is transmitted. Operations of block 1811 may be performed as discussed above with respect to operation 15 of FIG. 8.

Various operations from the flow chart of FIG. 17 may be optional with respect to some embodiments of service instance set nodes and related methods. Regarding methods of some embodiments, for example, operations of blocks 1809 and/or 1811 of FIG. 18 may be optional.

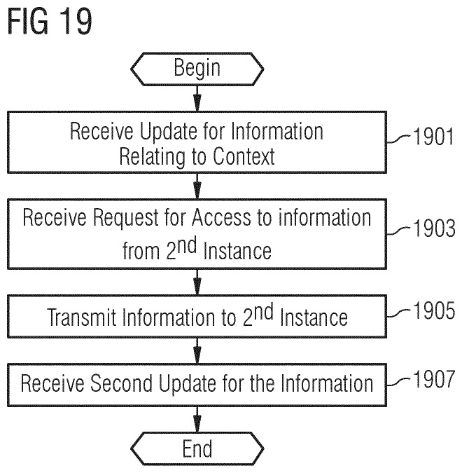

Operations of a set restoration storage resource node/entity/function/server 1301 for a service of a communication network will now be discussed with reference to the flow chart of FIG. 19 according to some embodiments of inventive concepts. For example, modules may be stored in memory 1305 of FIG. 12, and these modules may provide instructions so that when the instructions of a module are executed by processor 1303, processor 1303 performs respective operations of the flow chart of FIG. 19.

At bock 1901, processor 1303 may receive (through network interface 1307) an update for information relating to a context. The context may be associated with a device, a session, and/or a subscription. The update may be received from a first service instance set. The first service instance set may include a first plurality of instances of the service. The update may be received from a first instance of the service of the first service instance set. Operations of block 1901 may be performed as discussed above with respect to operation 7 of FIG. 8.

At bock 1903, processor 1303 may receive (through network interface 1307) a request for access to the information relating to the context from a second service instance set. The request for access may be generated responsive to the information relating to the context being unavailable at the second storage resource. The second service instance set may include a second plurality of instances of the service. The request may be received from a second instance of the service of the second service instance set Operations of block 1903 may be performed as discussed above with respect to operation 11 of FIG. 8.

At bock 1905, processor 1303 may transmit (through network interface 1307) the information relating to the context to the second service instance set responsive to receiving the request. The information may be transmitted to the second instance of the service of the second service instance set.

At bock 1907, processor 1303 may receive (through network interface 1307) a second update for the information relating to the context. The second update may be received from the second service instance set. The second update may be received from the second instance of the service of the second service instance set. Operations of block 1907 may be performed as discussed above with respect to operation 15 of FIG. 8.

In some embodiments, the first plurality of instances of the first service instance set may have access to a first storage resource. The second plurality of instances of the second service instance set may have access to a second storage resource. The first plurality of instances of the first service instance set may not have access to the second storage resource and the second plurality of instances of the second service instance set may not have access to the first storage resource.

Various operations from the flow chart of FIG. 19 may be optional with respect to some embodiments of service instance set nodes and related methods. Regarding methods of some embodiments, for example, operations of block 1907 of FIG. 19 may be optional.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Abbreviations used in the above disclosure:

Abbreviation Explanation

3GPP 3rd. Generation Partnership Project

5GC 5th Generation Core Network

AMF Access and Mobility Management Function

API Application Programming Interface

CN Core Network

CNA Cloud Native Architecture

DC Data Center

DNN Data Network Name

DNS Domain Name Server

LB Load Balancer

LCM Life Cycle Management

NF Network Function

NRF Network Repository Function

NSSAI Network Slice Selection Assistance Information

PDU Protocol Data Unit

SBA Service based Architecture

SIS Service Instance Set

SPoA Single Point of Access

SUPI Subscriber Permanent Identifier

UDSF Unstructured Data Storage Function

UE User Equipment

URI Uniform Resource Identifier

1. A method of operating a service instance set for a service of a communication network, the method comprising:
receiving an operation request for an instance of the service in the service instance set, wherein the operation request includes a context identifier; and
transmitting an update for information relating to a context associated with the context identifier to a set restoration storage resource node using the instance of the service responsive to receiving the operation request.

2. The method of claim 1 further comprising:
accessing context data from a storage resource for a context associated with the context identifier using the instance of the service; and
updating the context at the storage resource using the instance of the service responsive to receiving the operation request.

3. The method of claim 2, wherein the update is transmitted to the set restoration storage resource after updating the context at the storage resource.

4. The method of claim 2 further comprising:
transmitting an operation response after updating the context at the storage resource, wherein the operation response includes the context identifier and wherein the operation response is responsive to the operation request.

5. The method of claim 4, wherein the operation response includes the context identifier.

6. The method of claim 4, wherein receiving the operation request comprises receiving the operation request through an access node, and wherein transmitting the operation response comprises transmitting the operation response through the access node.

7. The method of claim 4, wherein receiving the operation request comprises receiving the operation request from a consumer node, and wherein transmitting the operation response comprises transmitting the operation response to the consumer node.

8. The method of claim 4, wherein receiving the operation request comprises receiving the operation request from a consumer node through an access node, and wherein transmitting the operation response comprises transmitting the operation response to the consumer node through the access node.

9. The method of claim 4, wherein transmitting the update comprises transmitting the update after transmitting the operation response.

10. The method of claim 1, wherein the service instance set comprises a plurality of instances of the service.

11. The method of claim 1, wherein the context identifier is associated with a device, session, and/or subscription.

12. A method of operating a service instance set for a service of a communication network, the method comprising:
receiving an operation request for the service from a consumer node, wherein the operation request includes a context identifier;
responsive to determining that a context associated with the context identifier is unavailable from a storage resource associated with the service instance set, accessing information relating to the context from a set restoration storage resource; and
updating the context at the storage resource associated with the service instance set responsive to receiving the operation request and responsive to receiving the information relating to the context from the set restoration storage resource.

13. The method of claim 12 further comprising:
transmitting an operation response after updating the context at the storage resource, wherein the operation response is responsive to the operation request.

14. The method of claim 13, wherein the operation response includes the context identifier.

15. The method of claim 13, wherein receiving the operation request comprises receiving the operation request through an access node, and wherein transmitting the operation response comprises transmitting the operation response through the access node.

16. The method of claim 13, wherein receiving the operation request comprises receiving the operation request from a consumer node, and wherein transmitting the operation response comprises transmitting the operation response to the consumer node.

17. The method of claim 13, wherein receiving the operation request comprises receiving the operation request from a consumer node through an access node, and wherein transmitting the operation response comprises transmitting the operation response to the consumer node through the access node.

18. The method of claim 12, further comprising:
transmitting an update for information relating to the context to the set restoration storage resource node based on the operation request.

19. The method of claim 18, wherein transmitting the update for information relating to the context comprises transmitting the update to the set restoration storage resource node after transmitting the operation response.

20. The method of claim 12, wherein the service instance set comprises a plurality of instances of the service.

21. The method of claim 12, wherein the context identifier is associated with a device, session, and/or subscription.

22. A method of operating a set restoration storage resource node of a communication network, the method comprising:
receiving an update for information relating to a context, wherein the update is received from a first service instance set;
receiving a request for access to the information relating to the context from a second service instance set; and
transmitting the information relating to the context to the second service instance set responsive to receiving the request.

23. The method of claim 22 further comprising:
receiving a second update for the information relating to the context, wherein the second update is received from the second service instance set.

24. The method of claim 23, wherein the update is received from a first instance of the service of the first service instance set, wherein the request is received from a second instance of the service of the second service instance set, wherein the information is transmitted to the second instance of the service of the second service instance set, and wherein the second update is received from the second instance of the service of the second service instance set.

25. The method of claim 22, wherein the update is received from a first instance of the service of the first service instance set, wherein the request is received from a second instance of the service of the second service instance set, and wherein the information is transmitted to the second instance of the service of the second service instance set.

26. The method of claim 22, wherein the first service instance set comprises a first plurality of instances of the service, and wherein the second service instance set comprises a second plurality of instances of the service.

27. The method of claim 26, wherein the first plurality of instances of the first service instance set have access to a first storage resource, wherein the second plurality of instances of the second service instance set have access to a second storage resource, wherein the first plurality of instances of the first service instance set does not have access to the second storage resource, and wherein the second plurality of instances of the second service instance set does not have access to the first storage resource.

28. The method of claim 27, wherein the request for access is generated responsive to the information relating to the context being unavailable at the second storage resource.

29. The method of claim 22, wherein the context is associated with a device, session, and/or subscription.

30.-37. (canceled)
